(19) United States
(12) Patent Application Publication
(10) Pub. No.: US 2023/0187704 A1
(43) Pub. Date: Jun. 15, 2023

(54) ELECTROCHEMICAL CELL

(71) Applicant: Johnson Matthey PLC, London (GB)

(72) Inventors: Jacob LOCKE, Abingdon, Oxfordshire (GB); Benjamin LLOYD, Abingdon, Oxfordshire (GB); Ashley COOKE, Abingdon, Oxfordshire (GB); Christopher COOK, Abingdon, Oxfordshire (GB); Diogo CARVALHO, Abingdon, Oxfordshire (GB)

(21) Appl. No.: 17/998,594

(22) PCT Filed: Jun. 7, 2021
(86) PCT No.: PCT/GB2021/051402

§ 371 Date: Nov. 11, 2022

(30) Foreign Application Priority Data
Jun. 8, 2020 (GB) 2008642.7

(51) Int. Cl. H01M 10/0569; H01M 10/052; H01M 4/134; H01M 4/62; H01M 4/133; H01M 4/04; H01M 10/058; H01M 4/1393

(52) U.S. Cl. CPC H01M 10/0569; H01M 10/052; H01M 4/134; H01M 4/625; H01M 4/133; H01M 4/043; H01M 10/058; H01M 4/1393; H01M 2004/021

(57) ABSTRACT

The present invention provides an electrochemical cell comprising an anode; an electrolyte having a solubility for sulfur-containing species of less than 15 mM; a cathode comprising greater than 65 wt. % sulfur, wherein the cathode comprises a carbon-sulfur composite material; and wherein the composite material comprises greater than 65 weight % sulfur based on the total weight of the composite material; and wherein the carbon sulfur composite material is formed from an electroconductive carbon material having an average pore volume of 1.5⁻³ cm3 g⁻¹ and an average pore diameter of less than 3 nm.

The present invention relates to a cathode for an electrochemical cell, and an electrochemical cell comprising such a cathode. The present invention also relates to a method of producing such an electrochemical cell.

### BACKGROUND

Secondary cells such as lithium-sulfur cells may be recharged by applying an external current to the cell. Rechargeable cells of this type have a wide range of potential applications. Important considerations when developing lithium-sulfur secondary cells include gravimetric and volumetric energy, cycle life and ease of cell assembly. Another example of a secondary cell is a sodium-sulfur cell.

### FIGURES

Various aspects of the invention are described, by way of example, with reference to the accompanying figures, in which:

FIG. 1 provides a thermogravimetric analysis of a carbon-sulfur composite in accordance with an embodiment of the invention.

FIG. 2 illustrates cycle life and cell energy for an electrochemical cell in accordance with an embodiment of the invention.

FIG. 3 illustrates voltage profile for the first cycle of an electrochemical cell in accordance with an embodiment of the invention.

FIG. 4 illustrates voltage profile for the first cycle of a cell in accordance with the invention (cathode comprising Maxsorb-III) and a comparative cell (cathode comprising Ketjen black).

### DESCRIPTION

Before particular examples of the present invention are described, it is to be understood that the present disclosure is not limited to the particular cell, method or material disclosed herein. It is also to be understood that the terminology used herein is used for describing particular examples only and is not intended to be limiting, as the scope of protection will be defined by the claims and equivalents thereof.

In describing and claiming the cell and method of the present invention, the following terminology will be used: the singular forms “a”, “an”, and “the” include plural forms unless the context clearly dictates otherwise. Thus, for example, reference to “an anode” includes reference to one or more of such elements.

In accordance with one aspect of the invention, there is provided an electrochemical cell comprising:

an anode;

an electrolyte having a solubility for sulfur-containing species of less than 15 mM;

a cathode comprising greater than 65 wt. % sulfur, wherein the cathode comprises a carbon-sulfur composite material,

wherein the composite material comprises greater than 65 weight % sulfur based on the total weight of the composite material; and wherein the carbon sulfur composite material is formed from an electroconductive carbon material having an average pore volume of 1.5-3 cm³ g⁻¹ and an average pore diameter of less than 3 nm.

In accordance with another aspect of the invention, there is provided a method for forming an electrochemical cell as detailed above, said method comprising:

providing a carbon host material having an average pore volume of 1.5-3 cm³ g⁻¹ and an average pore diameter of less than 3 nm;

introducing sulfur into the carbon host material to form a composite material;

depositing said composite material onto a current collector to form a cathode;

placing the cathode in contact with an electrolyte having a polysulfide solubility of less than 15 mM; and placing an anode in contact with the electrolyte.

As described above, the cell according to the present invention comprises a cathode having a pore structure that can enable high performance to be achieved. In particular, this may be achieved when the cathode described herein is combined with a specific type of electrolyte. The carbon-sulfur composite in the cathode comprises sulfur domains within the pores of the carbon host material that can enable a high sulfur content to be present within the composite material. The structure of the carbon-sulfur composite can enable the use of very low electrolyte loadings within the cell, for example an electrolyte loading of <2 μL/mAh. High utilisation of the active sulfur material can also be achieved. The electrolyte is selected to enable the proper functioning and performance of the carbon-sulfur material to enable a high energy cell to be produced. For example, a cell in accordance with the present invention may be a lithium-sulfur cell providing a specific energy of greater than 400 Wh/kg (or greater than 600 Wh/l), for example greater than 500 Wh/kg. A cell providing a coulombic efficiency of greater than 99.5% may be achieved, in particular during the initial charge and discharge cycle. Additionally, sulfur utilisation of greater than 90% (assuming a theoretical capacity of 1672 mA h g⁻¹ of sulfur) may be reached in a lithium-sulfur cell in accordance with an embodiment of the invention, i.e. equivalent to greater than 1504 mA h g⁻¹ of sulfur.

The electrolyte used in a lithium-sulfur cell according to the present invention can enable a high energy (for example, greater than 400 Wh kg⁻¹) lithium-sulfur cell to be produced. Preferably, this may be achieved without the need for the inclusion of certain additives in the electrolyte, in particular additives including N—O bonds. Such additives can be included in the electrolyte of a typical alkali metal-sulfur cell (for example, a lithium-sulfur cell) to prevent or limit the effect of polysulfide shuffle. An example of such a sacrificial additive is LiNO₃. However, these additives have certain disadvantages, such as depletion during cell operation and causing cell swelling due to formation of gases during cycling, particularly at higher temperatures. This may have safety implications, as well as an adverse effect on cycle life. The use of additives such as LiNO₃ to suppress redox shuttle of soluble polysulfides may also limit the voltage range of the cell; for example, the use of LiNO₃ additive may limit the discharge voltage to approximately 1.7 V (reduction potential of LiNO₃). Thus, the cell in accordance with the present invention may reduce or prevent polysulfide shuttle without the use of additives such as LiNO₃. Preferably, the electrolyte in accordance with the present invention does not comprise sacrificial additives. In a preferred embodiment, the electrolyte does not contain additives comprising N—O bonds, for example LiNO₃.

### Cathode

In accordance with the present invention, the cathode comprises a carbon-sulfur composite material. The carbon-sulfur composite material is formed of sulfur domains within the pores of a carbon host material. The cathode comprises greater than 65 wt. % sulfur, preferably greater than 70 wt. % sulfur, for example greater than 80 wt. % sulfur. The structure of the carbon material, in particular the size of the pores within the carbon material and the total pore volume present is such that, when the pores of the carbon material are filled with sulfur, the sulfur content of the composite material is greater than 65 wt. % sulfur, preferably greater than 70 wt. % sulfur, more preferably greater than 75 wt. % sulfur, for example greater than 80 wt. % sulfur. Thus, the structure of the carbon host within the cathode allows a cell containing a high proportion of active component mass to be formed. This can enable the preparation of lightweight cells.

As noted above, the cathode of the electrochemical cell includes at least one electroconductive carbon material. In accordance with the present invention, the carbon host structure advantageously has a specific pore structure and pore volume. The average pore volume of the carbon material is from 1.5-3 cm³ g⁻¹, preferably from 1.6-2.5 cm³ g⁻¹, for example from 1.7 to 2.0 cm³ g⁻¹. Exemplary carbon material Maxsorb-III (MSC-30) has an average pore volume of approximately 1.79 cm³ g⁻¹+/−0.2 (in other words, from about 1.59 to 1.99 cm³ g⁻¹). The carbon material has an average pore diameter of less than 3 nm, preferably less than 2.5 nm, for example less than 2 nm. In one embodiment, the carbon material has an average pore diameter of between 1 to 3 nm, preferably between 1.5 to 2.5 nm, for example between 1.75 to 2.25 nm. With regard to the pore size distribution in Maxsorb-III, this is largely made up of pores with a diameter of between 1-3 nm.

In the carbon material in accordance with the present invention, the pore size distribution may be such that at least 45% of the pores in the carbon material have a diameter falling within the range of 1-3 nm. Preferably, at least 50% of the pores fall within the range of 1-3 nm, for example at least 60% of the pores fall within the range of 1-3 nm. In accordance with a preferred embodiment of the invention, from 45 to 75% of the pores in the carbon material have a diameter of between 1-3 nm, for example 50 to 70% of the pores in the carbon material have a diameter of between 1-3 nm. The other pores in the carbon material may either be micropores, mesopores, or a combination thereof. The carbon material in accordance with the present invention may comprise from 10-49% of pores having a diameter of less than 1 nm, for example from 20-40% pores having a diameter of less than 1 nm. Additionally or alternatively, the carbon host material may comprise from 1-30 pores having a diameter of greater than 3 nm, for example 5-20% of pores having a diameter of greater than 3 nm.

The carbon material may comprise micropores, or mesopores, or a combination thereof. Pore dimensions (average diameter, and volume) may be measured by any suitable method, for example BET analysis (using nitrogen gas). In accordance with the IUPAC definition of a microporous material, this contains pores having a pore diameter of less than 2 nm, with a mesoporous material containing pores having a pore diameter of between 2 nm and 50 nm. Any carbon material with a suitable pore structure may be contemplated, for example commercially available high surface area carbon materials such as Maxsorb-III (MSC-30). Alternatively, a carbon material having a suitable pore structure may be manufactured using any suitable method. Examples of such methods include templating or activation, where “templating” refers to a bottom-up method for manufacturing a carbon host material, and “activation” refers to a top-down method. In one example, a carbon host material may be produced via chemical activation of a carbon feedstock. In another example, a suitable carbon host material may be formed via pyrolysis of a carbon-containing precursor. Formation of the carbon material may either be self-templated e.g. pyrolysis of a MOF (metal organic framework) or involve the application of a structural template e.g. pyrolysis of a precursor material within zeolite template. In another embodiment, the carbon material may be formed from carbon fibres. In this embodiment, the carbon fibres may have an average diameter of between 0.5 to 50 μm, preferably 5 to 30 μm, for example 10 to 20 μm. The length of such carbon fibres may be between 100 μm to 30 cm, preferably between 500 μm and 10 cm, for example between 1 mm and 1 cm. In this embodiment, the carbon material may take the form of a carbon fibre mat comprising at least one carbon fibre.

In a preferred embodiment, the electroconductive carbon host material which forms the S/C composite material has an average pore volume of from 1.5-2.5 cm³ g⁻¹, for example from 1.5-2.0 cm³ g⁻¹, and an average pore diameter of from 1 nm to 3 nm.

The carbon material can, when combined with sulfur to form a carbon-sulfur composite, enable low electrolyte loadings to be applied. For example, an electrolyte loading of less than 1.7 μL /mAh (of sulfur within the cathode, energy calculated assuming 1672 mA h g⁻¹ of sulfur) may be achieved. This is in comparison to a standard lithium-sulfur cell which may have a typical electrolyte loading of >2 μL/mAh. This may enable production of lightweight cells, and high utilisation of sulfur within the cell. Without wishing to be bound by any theory, it is believed that the size and volume of the pores within the carbon host material can advantageously provide a high level of sulfur utilisation, for example a sulfur utilisation of greater than 1550 mA h g⁻¹ (s) at room temperature (20° C.) and c-rate C/10. It is believed that the pore structure in accordance with the present invention may provide an electron tunnelling distance that can maximise the amount of sulfur within the carbon host that is supplied with electrons, thus providing a high level of sulfur utilisation. Without wishing to be bound by any theory, a carbon pore diameter of between 1-3 nm may provide an improved carbon-sulfur interface, and may improve the amount of sulfur that is electrochemically active (i.e. is within a certain distance of the carbon host material). For example, improved sulfur utilisation may be demonstrated in comparison to an alternative carbon material such an Ketjen black, which has a larger pore size.

The cathode of the electrochemical cell includes at least one electrochemically active sulfur material. The electrochemically active sulfur material may comprise elemental sulfur, sulfur-based organic compounds, sulfur-based inorganic compounds and sulfur-containing polymers, or combinations thereof. Preferably, elemental sulfur or an alkali metal sulfide such as Li₂S or Na₂S is used. The electroactive sulfur material may contain sulfur as well as additional elements such as Li, Na, Mg, P, N, Si, Ge, Ti, Zr, Sn, B, A, F, CI, Br, I, ) or any combination thereof. Examples of sulfur-containing materials include LGPS, Li₃PS₄, and Li₇P₃S₁₁. Where an alkali metal sulfide such as Li₂S is used, this may be provided within the electrode structure via a chemical or electrochemical lithiation or sodiation. This may be performed either prior to electrode formation, or prior to cell build.

The pore structure of carbon material in the cathode can enable a high proportion of sulfur to be hosted therein. The electrochemically active sulfur material may form at least 65 wt %, preferably at least 70 wt % of the total weight of the cathode. For the avoidance of doubt, this total weight refers to the weight of the cathode inclusive of carbon-sulfur material, binder and other additives, but excludes the weight of a separate current collector where present. In one embodiment, the electrochemically active sulfur material may form 65 wt % to 95 wt %, preferably 70 wt % to 85 wt %, for example 75 wt % to 80 wt % of the total weight of the cathode. Without wishing to be bound by any theory, it is believed that the composite material forming a cathode in a cell in accordance with the present invention can enable high utilisation of sulfur during cycling of the cell. The high weight percentage of sulfur can provide a cell containing a high proportion of active component mass within the cathode. This can enable production of lightweight cells.

The cathode may further comprise an electronically conductive carbon. Examples of electronically conductive carbon materials include carbon black or carbon nanotubes, or combinations thereof. The cathode may also further comprise a binder. Examples of suitable binders include carboxymethyl cellulose, polyacrylates, polyacrylic acid, gelatin, alginates, alginic acid, and mixtures thereof. Preferably, the binder has a high molecular weight i.e. greater than 100,000. The cathode may comprise 1 to 20 weight % binder based on the total weight of the binder, composite particles and optional electronically conductive carbon particles. The cathode may comprise 5 to 40 wt % electronically conductive carbon materials based on the total weight of the composite particles, electronically conductive carbon particles and optional binder.

### Anode

Any suitable anode may be employed. Preferably, the anode may comprise an alkali metal, in particular lithium or sodium. In a lithium-sulfur cell, the lithium anode comprises an electrochemically active substrate comprising lithium. The electrochemically active substrate may comprise a lithium metal or lithium metal alloy. Preferably, the electrochemically active substrate comprises a foil formed of lithium metal or lithium metal alloy. Examples of lithium alloys include lithium aluminium alloy, lithium magnesium alloy and lithium boron alloy. Preferably, a lithium metal foil is used. Where the cell is a sodium-sulfur cell, the anode comprises a sodium metal or sodium metal alloy. Preferably, the anode comprises a foil formed of sodium metal or sodium metal alloy. Examples of sodium alloys include sodium aluminium alloy, sodium magnesium alloy and sodium boron alloy. Preferably, a sodium metal foil is used. As an alternative, the anode may comprise an alternative material such as silicon or carbon, for example a silicon-containing composite such as a carbon-silicon composite, or for example graphite. In one embodiment, the electrode may be lithiated or sodiated, either prior to electrode formation, or prior to cell build. In another embodiment, the anode may take the form of a current collector comprising an electronically conducting substrate, an electrically conductive metallic foil, sheet or mesh. A current collector may typically be composed of a metallic conductor that is substantially inert, i.e. the metallic conductor does not participate in reduction or oxidation reactions during cycling of the cell. For example, the current collector may not be formed of an alkali metal such as lithium or sodium. Examples of suitable metals for formation of the current collector include inert metals such as aluminium, copper, nickel, titanium or tungsten. In a preferred example, the current collector comprises copper or nickel, for example copper or nickel foil. The current collector may also comprise a metallic conductor as defined above, wherein the metallic conductor is applied to a substrate, such as a polymer substrate. The substrate may take the form of a polymer such as polyethylene terephthalate (PET). The current collector may have a thickness of between 5 μm and 40 μm, preferably between 10 μm and 25 μm, for example between 15 μm and 20 μm.

As used throughout the specification, the term “anode” refers to the negative electrode in an electrochemical cell, i.e. the electrode at which oxidation occurs during charge of the cell. As used throughout the specification, the term “cathode” refers to the positive electrode in an electrochemical cell, i.e. the electrode at which reduction occurs during charge of the cell.

A coating on the surface of the anode may be included. At least one or more coating layers may be envisaged. This coating may form an anode protection layer. Such anode coating layer may have beneficial effects on cell performance, for example by reducing inhomogeneous stripping and plating of the alkali metal present in the anode, which may reduce cracks or voids in the anode surface and may provide improvements in cycling and capacity life.

For example, one or more coating layers comprising at least one metal and/or non-metal that can form an alloy with an alkali metal such as lithium or sodium may be employed. The term “alloy” refers to a combination of two or more metals, or a combination of one or more metals with other, non-metallic elements. Examples of suitable alloying metals and non-metals include aluminium, gallium, boron, indium, zinc, carbon, silicon, germanium, tin, lead, antimony, silver, gold, sodium, potassium, magnesium, calcium, bismuth, tellurium, palladium, platinum and mixtures thereof. The thickness of the coating layer comprising at least one metal and/or non-metal that can form an alloy with an alkali metal such as lithium or sodium may be between 1 nm and 5000 nm, preferably between 10 nm and 3000 nm, for example between 100 nm and 1000 nm. In one embodiment, a coating layer comprising at least one metal and/or non-metal that can form an alloy with an alkali metal is deposited directly on the electrochemically active alkali metal layer.

Additionally or alternatively, one or more ionically conducting coating layers may be included as a part of the anode structure, either directly on the electrochemically active alkali metal layer, or on top of a further coating layer. Said ionically conducting coating layer may have an electronic conductivity of less than 10⁻⁵ S cm⁻¹. Thus, this layer may have a low electronic conductivity, i.e. be substantially electronically insulating. The inclusion of a layer with a low electronic conductivity may avoid deposition of alkali metal ions such as Li⁺ and Na⁺ on top of a layer comprising at least one metal and/or non-metal that can form an alloy with an alkali metal such as lithium or sodium, where such a layer is present between the ionically conducting coating layer and the anode. Low electronic conductivity may also serve to prevent the ionically conducting coating layer from effectively working as a further current collector within the cell. The ionically conducting coating layer may have an electronic conductivity of less than 10⁻⁵S cm', preferably less than 10⁻⁸S cm', more preferably less than 10⁻¹⁰ S cm⁻¹. In one example the electronic conductivity is less than 10⁻¹²S cm⁻¹. Said ionically conducting coating layer may have a thickness of between 1 nm and 5000 nm, preferably between 10 nm and 1000 nm, for example between 100 nm and 500 nm.

The ionically conducting coating layer may comprise at least one of a ceramic or glass material, a polymer material, a polymer and ceramic composite material, and combinations thereof. Suitable ceramic or glass materials include, for example, one or more elements selected from lithium, sodium, magnesium, oxygen, phosphorous, nitrogen, silicon, germanium, titanium, zirconium, tin, aluminium, sulfur, boron, selenium, fluorine, chlorine, bromine or iodine. Suitable ceramic materials may be stoichiometric or non-stoichiometric. The ceramic material may be an oxynitride, sulphide, phosphate, oxide, oxysulfide, thiophosphate, borate, oxyborate, borohydride, silicate, aluminate or thioaluminate compound, or a combination thereof. Examples of suitable materials include lithium oxynitride, lithium sulphide, lithium phosphate, lithium oxide, lithium oxysulfide, lithium thiophosphate, lithium borate, lithium oxyborate, lithium borohydride, lithium silicate, lithium aluminate and lithium thioaluminate, or combinations thereof. Alternatively, the material may be selected from one or more of sodium oxynitride, sodium sulphide, sodium phosphate, sodium oxide, sodium oxysulfide, sodium thiophosphate, sodium borate, sodium oxyborate, sodium borohydride, sodium silicate, sodium aluminate and sodium thioaluminate. The ceramic material may be an amorphous material.

The ionically conducting coating layer may comprise a conductive polymer material, for example an ionically conductive polymer. Additionally or alternatively, the ionically conducting coating layer may comprise a polymer material having an alkali metal salt distributed within the polymer material. This may provide or increase ionic conductivity within the polymer. The ionically conducting coating layer may instead or additionally comprise a polymer-ceramic composite material. A polymer-ceramic composite material may comprise ceramic particles that are bound together by at least one polymer material. The polymer or polymers used to form the polymer-ceramic composite material may have inherent alkali metal ion conductivity, or may be mixed with alkali metal salts.

For example, the polymer material may comprise a lithium salt (e.g. LiTFSI) dissolved within a polymer phase, for example polyethylene oxide. Further examples of lithium salts include lithium hexafluorophosphate, lithium hexafluoroarsenate, lithium nitrate, lithium perchlorate, lithium trifluoromethanesulfonimide, lithium bis(oxalate) borate and lithium trifluoromethanesulphonate. Suitable sodium salts include sodium hexafluorophosphate, sodium hexafluoroarsenate, sodium nitrate, sodium perchlorate, sodium trifluoromethanesulfonimide, sodium bis(oxalate) borate and sodium trifluoromethanesulphonate. Combinations of salts may be employed.

The polymer may comprise at least one functional group selected from the list of amine, amide, carbonyl, carboxyl, ether, thioether and hydroxyl groups, and mixtures thereof. Non-limiting examples of polymers include polyanhydrides, polyketones, polyesters, polystryenes, polyamides, polyimides, polyurethanes, polyolefins, polyvinylenes. Non-limiting examples of ionically conductive polymers may include nitrogen or sulfur containing polymers, for example polycarbazoles, polyindoles, polyazepines, polyanilines, polythiophenes, PPS. Further examples of ionically conductive polymers may include poly(fluorene)s, polyphenylenes, polypyrenes, polyazulenes, polynaphthalenes, poly(acetylene)s (PAC) and poly(p-phenylene vinylene) (PPV). In a preferred embodiment, the polymer material is polyethylene oxide.

In a preferred embodiment, the anode is coated with a first layer comprising a metal and/or non-metal that alloys with an alkali metal, and a second layer deposited on the first layer, wherein the second layer is an ionically conducting layer having an electronic conductivity of less than 10⁻⁵S cm⁻¹, wherein the first and second layers are as detailed above. Coatings comprising more than one of either the layer comprising a metal and/or non-metal that alloys with an alkali metal, or the ionically conducting layer, may be envisaged. Additional layers may also be included. Any suitable method may be used to form the coating layer or layers. Examples of suitable methods include physical or chemical deposition methods, such as physical or chemical vapour deposition. For example, plasma-enhanced chemical vapour deposition, sputtering, evaporation, electron-beam evaporation, and chemical vapour deposition (CVD) may be used. Alternative methods of forming coating layers may include ink-jet printing, slot die, spray coating and atomic layer deposition.

### Electrolyte

Any suitable solvent system or liquid or gel or mixture of liquids and/or gels may be used for the electrolyte. The electrolyte in accordance with the present invention has a low solubility for polysulfides, or in some cases the electrolyte may not dissolve polysulfides. Correspondingly, the electrolyte has a low solubility for sulfur-containing species in general (such as elemental sulfur, LiₓSₙ or Li₂S). In accordance with the present invention, the electrolyte has a solubility for sulfur-containing species at room temperature of less than 15 mM, preferably less than 10 mM, for example less than 5 mM at room temperature (20° C.). The combination of electrolyte and cathode in accordance with the present invention may also allow low volumes of electrolyte to be employed in a cell, despite the low solubility of polysulfides within the electrolyte system.

Given the example of a traditional lithium-sulfur cell, an electrolyte with a high solubility for lithium polysulfide species is required. The capacity of such a cell is dependent on the solubility and therefore the electrolyte volume available within the cell. Electrolytes of the present invention, such as highly concentrated electrolytes, have a low solubility for polysulfide intermediates. If an electrolyte having a low solubility for sulfur-containing species is used in combination with a traditional cathode, much more electrolyte is required to achieve a high capacity, as much more electrolyte is required to solubilise the active material. However, a larger volume of electrolyte is disadvantageous as it increases the size and weight of the cell and results in a low specific energy. In this invention, the formation of solid polysulfide species does not require large volumes of electrolytes. Furthermore, the porosity provided by the specific cathode structure may decrease the cathode/electrolyte interface and further decrease the need for large electrolyte volumes.

Preferably, the electrolyte is liquid across the range of operating temperatures of the cell, which may be from −30 to 120 ° C., preferably from −10 to 90 ° C., for example from 0 to 60 ° C. Operating pressures of the cell may be from 5 mbar to 100 bar, preferably from 10 mbar to 50 bar, for example 100 mbar to 20 bar. In one example, the cell may be operated at room temperature and pressure. Preferably, the electrolyte is a liquid electrolyte, which enables wetting of the carbon-sulfur composite material, ensuring ionic conduction between the anode and cathode. Additionally, the electrolyte in accordance with the invention is stable to alkali metals such as lithium, and does not dissolve the active material species (i.e. sulfur-containing material). This may enable high utilisation within the cell, and stable cell operation.

The liquid electrolyte may be a gel electrolyte. Alternatively, the electrolyte phase may be a solid ionically conductive material.

Preferably, the electrolyte has a density of less than 1.5 g cm⁻³.

Suitable organic solvents for use in the electrolyte are ethers (e.g. linear ethers, diethyl ether (DEE), diglyme (2-methoxyethyl ether), tetraglyme, tetrahydrofuran, 2-methyltetrahydrofuran, dimethoxyethane (DME), dioxolane (DIOX)); carbonates (e.g. di methylcarbonate, diethylcarbonate, ethylmethylcarbonate, methylpropylcarbonate, ethylene carbonate (EC), propylene carbonate (PC); sulfones (e.g. dimethyl sulfone (DMS), ethyl methyl sulfone (EMS), tetramethyl sulfone (TMS)); esters (e.g. methyl formate, ethyl formate, methyl propionate, methylpropylpropionate, ethylpropylpropionate, ethyl acetate and methyl butyrate); ketones (e.g. methyl ethyl ketone); nitriles (e.g. acetonitrile, proprionitrile, isobutyronitrile); amides (e.g. dimethylformamide, dimethylacetamide, hexamethyl phosphoamide, N, N, N, N-tetraethyl sulfamide); lactams/lactones (e.g. N-methyl-2-pyrrolidone, butyrolactone); ureas (e.g. tetramethylurea); sulfoxides (e.g. dimethyl sulfoxide); phosphates (e.g. trimethyl phosphate, triethyl phosphate, tributyl phosphate); phosphoramides (e.g. hexamethylphosphoramide). Further suitable solvents include toluene, benzene, heptane, xylene, dichloromethane, and pyridine.

Any of the ethers, carbonates, sulfones, esteaars, ketones, nitriles, amides, lactams, ureas, phosphates, phosphoramides may be halogenated or partially halogenated. For example, any of the solvents detailed above may be fluorinated or partially fluorinated. An example of a fluorinated ether is 1,1,2,2,-tetrafluoroethyl-2,2,3,3-tetrafluoropropyl ether.

Any combination of one or more of the above solvents may be included in the electrolyte.

In an alternative embodiment, the electrolyte may comprise one or more ionic liquids as solvent. Said ionic liquids may comprise salts comprising organic cations such as imidazolium, ammonium, pyrrolidinium, and/or organic anions such as bis(trifluoromethanesulfonyl)imide TFSI⁻, bis(fluorosulfonyl)imide FSI⁻, triflate, tetrafluoroborate BF₄⁻, dicyanamide DCA⁻, chloride Cl⁻. The ionic liquid is liquid at room temperature (20° C.). Examples of suitable ionic liquids include (N,N-diethyl-N-methyl-N(2methoxyethyl)ammonium bis(trifluoromethanesulfonyl), N,N-Diethyl-N-methyl-N-propylammonium bis(fluorosulfonyl)imide, N,N-Diethyl-N-methyl-N-propylammonium bis(fluorosulfonyl)imide, N,N-dimethyl-N-ethyl-N-(3-methoxypropyl)ammonium bis(fluorosulfonyl)imide, N,N-dimethyl-N-ethyl-N-(3-methoxypropyl)ammonium bis(trifluoromethanesulfonyl)imide, N,N-Dimethyl-N-ethyl-N-benzylAmmonium bis(trifluoromethanesulfonyl)imide, N,N-Dimethyl-N-Ethyl-N-Phenylethylammonium bis(trifluoromethanesulfonyl)imide, N-Ethyl-N,N-dimethyl-N-(2-methoxyethyl)ammonium bis(fluorosulfonyl)imide, N-Ethyl-N,N-dimethyl-N-(2-methoxyethyl)ammonium bis(trifluoromethanesulfonyl)imide, N-Tributyl-N-methylammonium bis(trifluoromethanesulfonyl)imide, N-Tributyl-N-methylammonium dicyanamide, N-Tributyl-N-methylammonium iodide, N-Trimethyl-N-butylammonium bis(trifluoromethanesulfonyl)imide, N-Trimethyl-N-butylammonium bromide, N-Trimethyl-N-hexylammonium bis(trifluoromethanesulfonyl)imide, N-Trimethyl-N-propylammonium bis(fluorosulfonyl)imide, N-Trimethyl-N-propylammonium bis(trifluoromethanesulfonyl)imide, (N,N-diethyl-N-methyl-N(2methoxyethyl)ammonium bis(fluorosulfonyl)imide, 1-Butyl-1-methylpyrrolidinium bis(fluorosulfonyl)imide, 1-Ethyl-3-methylimidazolium bis(fluorosulfonyl)imide, 1-Methyl-1-(2-methoxyethyl)pyrrolidinium bis(fluorosulfonyl)imide, N,N-Diethyl-N-methyl-N-propylammonium bis(fluorosulfonyl)imide, N-Ethyl-N,N-dimethyl-N-(2-methoxyethyl)ammonium bis(fluorosulfonyl)imide, N-propyl-N-methylpiperidinium bis(fluorosulfonyl)imide, N-Trimethyl-N-butylammonium bis(fluorosulfonyl)imide, N-methyl-N-butyl-piperidinium bis(trifluoromethanesulfonyl) imide, N-methyl-N-propylpyrrolidinium bis(trifluoromethanesulfonyl)imide and combinations thereof.

Alternatively or additionally, the liquid electrolyte may be a gel electrolyte. The gel electrolyte may comprise polyethylene oxide with a gelling liquid electrolyte, for example an ether such as dimethyl ether. In one example, the electrolyte may comprise polyethylene oxide in combination with LiTFSI in dimethylether.

Examples of solid electrolytes may include garnet-type structures such as LLZO, NASICON-type conductors such as LATP, sulfide electrolytes such as LPS (e.g. Li₆PS₅Cl), LGPS. Polymer-based solid ionically conductive materials may also be envisaged e.g. PEO+LiTFSI. Ionic conductivity enhancers such as inorganic additives like clay minerals may also be used, for example halloysite.

Any combination of the above solvents may be employed in the electrolyte. For example, the electrolyte may comprise the combination of an ionic liquid with a fluorinated ether, or the combination of an ionic liquid within a gel, or the combination of a fluorinated ether within a gel. Any other combination of two or more of the liquids and/or gels detailed above may be envisaged.

In a preferred embodiment the solvent of the electrolyte may be selected from dimethoxyethane.

Suitable alkali metal salts for inclusion in the electrolyte include lithium or sodium salts. Suitable lithium salts include lithium hexafluorophosphate, lithium hexafluoroarsenate, lithium nitrate, lithium perchlorate, lithium trifluoromethanesulfonimide, lithium bis(trifluoromethanesulfonyl)imide, lithium bis(fluorosulfonyl)imide, lithium bis(oxalate) borate and lithium trifluoromethanesulphonate. Suitable sodium salts include sodium hexafluorophosphate, sodium hexafluoroarsenate, sodium nitrate, sodium perchlorate, sodium trifluoromethanesulfonimide, sodium bis(trifluoromethanesulfonyl)imide, sodium bis(fluorosulfonyl)imide, sodium bis(oxalate) borate and sodium trifluoromethanesulphonate. Preferably the lithium salt is lithium trifluoromethanesulphonate (also known as lithium triflate). Combinations of salts may be employed. For example, lithium triflate may be used in combination with lithium nitrate. The lithium salt may be present in the electrolyte at a concentration of 0.1 to 6 M, preferably, 0.5 to 4 M, for example, 3 to 3.5 M. In a preferred embodiment the salt may be selected from LITFSI.

The concentration of the at least one lithium or sodium salt in the solvent may be at least 75% of the saturation concentration of the solvent system, preferably at least 80% of the saturation concentration of the solvent, for example at least 85% of the saturation concentration of the solvent, for example at least 90% of the saturation concentration of the solvent. In one example, the concentration of the solvent is about 100% of the saturation concentration, i.e. the electrolyte may be fully saturated. The term “saturation concentration” is the extent of solubility of a particular substance in a specific solvent. When the saturation concentration is reached, adding more solute (for example, more lithium salt) does not increase the concentration of the solution. Instead, the excess solute precipitates out of solution. The saturation concentration is determined at room temperature, for example at 20° C. The saturation concentration of polysulfides within a particular solvent may be determined by known methods, for example by determining the point at which just enough electrolyte is added to dissolve all solid residues.

### Method

In accordance with an aspect of the invention, there is provided a method for forming an electrochemical cell as described above. The electrochemical cell in accordance with the present invention is preferably an alkali or alkaline earth metal cell, for example a lithium-sulfur or sodium-sulfur cell.

In the method of the present invention, a carbon host material having an average pore volume of at least 1.5 to 3 cm³ g⁻¹ and an average pore diameter of less than 3 nm is provided. The carbon host material may be as detailed above.

Optionally, the particle size of the carbon host material is reduced prior to the introduction of sulfur. Any suitable method may be used, for example, impact of carbon particles each other and/or with other objects (such as balls, in ball milling) can reduce particle size. Suitable methods of particle size reduction include ball milling, jet milling, or combinations thereof. In a preferred embodiment, ball milling is used. A further step of particle size selection may be performed. This particle size selection may be carried out by any suitable method. For example, particle size selection may be performed by sieving, or methods of separation by mass such as separation using a vortex. Size selection may result in carbon particles having a diameter of from 0.5 to 50 μm, preferably 5 to 30 μm, for example 10 to 20 μm. Reduction and/or selection of a particular particle size may enable preparation of a more homogeneous and/or dense electrode. Particle size selection may also be based on the desired performance of the resulting cell. For example, a bimodal distribution of particle size may be selected, or selection of a lower average particle size may be made.

Electrochemically active sulfur material is introduced into the carbon host material to form a carbon-sulfur composite material. The cathode starting materials may be combined by any suitable method. Preferably, the sulfur material infiltrates the carbon host structure, such that the sulfur material fills pores within the carbon host structure. Any suitable method of combining the carbon and sulfur materials that essentially retains the structure of the carbon host material may be used, for example ball milling, precipitation, or a melt infusion or diffusion process. In a preferred embodiment, melt infusion is used. For example, heating of the carbon and sulfur materials at a temperature of between 125-155° C. under a static vacuum may produce a carbon-sulfur composite material. Effective infiltration of the sulfur material into the carbon host enables a composite structure having a high proportion of sulfur to be obtained. In one embodiment, the sulfur material fills all the pores within the carbon host structure.

In one embodiment, the method further comprises grinding the carbon-sulfur composite material. This may result in a reduced particle size. In addition, mechanical grinding of the composite material can provide effective mixing of the carbon and sulfur materials, and may provide a high interface between the resulting particles. For example, impact of particles within the composite material with each other and/or with other objects (such as balls, in ball milling) can reduce particle size. Suitable methods include ball milling or jet milling, or combinations thereof. In a preferred embodiment, ball milling is used. Without wishing to be bound by theory, it is believed that methods such as ball milling, melt infusion, co-extrusion or jet milling may result in a cathode having a high sulfur/carbon interface. The cathode materials may additionally be mixed by a simple mixing process before any of the methods above are employed.

Ball milling is performed in a ball mill. In a ball milling, the ball mill is rotated such that balls (made of, for example, steel, titanium, agate, ceramic or rubber) inside the mill impact with the cathode materials. Jet milling is performed in a jet mill. A jet mill grinds and mixes the cathode materials by using a jet of compressed air or inert gas to impact the materials into each other. Milling can be performed over a time period of between 1 minute to 48 hours, preferably 10 minutes to 24h, more preferably 25 minutes to 10 hours, for example 25min to 4h. The speed of rotation of the ball mill can range from 50 rpm to 1,000 rpm, preferably 250 to 750 rpm, for example 350 to 500 rpm. An example of a suitable ball mill is a Fritsch ‘Pulverisette 6’ planetary mon mill.

Following the processes detailed above, the particle size may be reduced. Final particle size may be within the range of up to 50 μm, preferably up to 30 μm, for example up to 10 μm. For example, particle sizes may fall within the range of 0.1 μm to 50 μm, preferably 5 μm to 40 μm, for example 15 μm to 30 μm. By particle size, it is meant the maximum length of the particle in any direction. For example, the particle diameter may be within the range of up to 10 μm, preferably up to 5 μm, for example up to 3 μm. This particle size selection may be carried out by any suitable method. For example, particle size selection may be performed by sieving, or methods of separation by mass such as separation using a vortex.

Following the processes detailed above, additional electronically conductive additives, for example, electronically conductive carbon such as carbon black or carbon nanotubes, and/or other ionically conductive additives such as LGPS may be added to the electrochemically active sulfur/carbon mixture. Further mixing may take place to evenly distribute the additives throughout the mixture. Alternatively, additives may be combined with the carbon host material in advance of sulfur infiltration.

Following combination of the cathode starting materials, the mixture may be processed via any suitable process to result in a suitable cathode e.g. mixed with solvent (e.g. water or organic solvent) and optional binder to form a slurry. Any suitable solvent may be selected, provided that the solvent does not solubilise the active material, so as to ensure that the carbon-sulfur material structure is maintained. For example, where the active sulfur material is elemental sulfur, a water-based slurry may be formed. In another example, where the active sulfur material is Li₂S, a non-aqueous slurry may be provided, for example an organic solvent such as N-methyl-2-pyrrolidone. Any suitable binder may be used. Exemplary binders include carboxymethyl cellulose, polyacrylates, polyacrylic acid, gelatin, alginates, alginic acid, and mixtures thereof. Alternatively, the binder may be added to the carbon host material before sulfur infiltration. Other additives may be added to the slurry to stabilise the slurry or adjust the pH. Such additives include pH buffers, ionic or non-ionic surfactants, or clay type surfactants.

The slurry is applied to a current collector and then dried to remove the solvent. Alternatively, coating may be performed via a dry process (e.g. via extrusion). Optionally, pressing or calendaring steps may be employed. The resulting structure may then be cut into the desired shape to form a cathode. The thickness of the resulting cathode may be in the range of 1 to 100 μm, preferably 15 to 80 μm, for example 20 to 50 μm. An optional step to remove excess sulfur may be conducted. This may involve sublimation, thermal treatment (optionally under vacuum) or washing in a solvent with high sulfur solubility (for example, CS₂). Removal of excess sulfur may additionally or alternatively be conducted following preparation of the carbon-sulfur composite, before formation of the cathode.

Following production of the cathode, the cathode is placed into contact with an electrolyte having a polysulfide solubility of less than 15 mM; and an anode comprising an alkali metal or alkali metal alloy layer is placed in contact with the electrolyte to form an electrochemical cell. A separator may also be incorporated into the cell.

### Cell

A cell in accordance with the present invention may be provided in a suitable housing. This housing can define the electrochemical zone. Preferably, the housing is flexible, for example a flexible pouch. The pouch may be formed of a composite material, for example a metal and polymer composite. In one embodiment, one or more cells is enclosed in the housing. The cell or cells may be sealed in the pouch. A region of each of the cell or cells may protrude from the housing. This region may be coupled to a contact tab formed of, for example, nickel. The contact tab may be connected to the alkali metal or alkali metal alloy by any suitable method, for example by (ultrasonic) welding. Alternatively, the contact tab itself may protrude from the housing. Where a plurality of electrochemical cells are present in the cell assembly, a region of each of the anodes may be pressed or coupled together to form a pile of anodes that may be connected to a contact tab.

A cell in accordance with the present invention may be subjected to a force. Preferably, the force is an anisotropic force i.e. has a different value when measured in different directions. A component of the force is applied, for example is normal to, an active surface of the anode of the electrochemical cell. In one embodiment, the force is applied continuously to the cell. In one embodiment, the force is maintained at a particular value. Alternatively, the force may vary over time. The force may be applied across the entire surface of the anode. Alternatively, the force may be applied over a portion of the surface of the anode, such as over at least 80% of the surface, preferably over at least 60%, preferably over at least 40% of the surface, for example over at least 20% of the surface. The force may be applied directly to the cell. Alternatively, the force may be applied to one or more plates, for example metal plates, that are situated outside of the cell or stack of cells. The force may be applied externally to the housing in which one or more cells is contained. For example, one or more cells may be contained within a flexible pouch, and a force may be applied externally to the flexible pouch.

The force may enhance the performance of an electrochemical cell. Without wishing to be bound by any theory, it is believed that the pressure applied to the anode enables intimate contact to be maintained between a protection layer and the alkali metal or metal alloy layer. The application of pressure to the anode may enable formation of alkali metal plating below the protection layer, between the protection layer and the alkali metal/metal alloy. This may avoid or reduce the formation of plating on top of the protection layer, which may be inhomogeneous and may result in cracking or pitting on the surface. Where plating occurs under the protection layer, the smooth surface of the anode may be preserved, and the formation of cracks or voids on the surface may be reduced. Dendrite formation may then be prevented. Furthermore, alkali metal depositions located under the protection layer are not in direct contact with the electrolyte. This may prevent the electrolyte from being reduced during cycling, which may avoid a reduction in cycle life of a cell.

In one embodiment, the force may be a clamping force. Alternatively, the force may be a compression force. The clamping force may be applied to the cell using a clamp. Alternatively, one or more constricting elements may be positioned around the exterior of the cell or cells. The constricting element may take the form of a band or tubing that surrounds at least part of the exterior of the cell or cells. The band may be made of any suitable material. In one embodiment, the band is formed of an elastic material that may be stretched around the cell or cells and, when in position, applies a constricting force. In one embodiment, the band is an elastic band. Alternatively, the band may be tightened around the cell or cells. The constricting element may also take the form of a shrink wrap material. In a further arrangement, one or more compression springs may be used, for example the cell or cells may be contained within a containment structure in which one or more compression springs are located between the containment structure and the cell. Other means of applying force can include screws or weights.

One or more of the above methods of applying a force may be employed. Any suitable force of greater than 0 MPa may be used. The force applied to the cell or cells may be within the range of up to 0.5 MPa, preferably up to 2 MPa, for example up to 5 MPa. The force may be at least 0.1 MPa, preferably at least 0.5 MPa, for example at least 1 MPa. The force may be between 0.1 MPa and 5 MPa, preferably between 0.5 MPa and 3 MPa, for example between 1 MPa and 1.5 MPa.

### EXAMPLES

### Example 1

30 g of Maxsorb Ill (MSC-30) was combined and physically mixed with 70 g of sublimed sulfur at room temperature. The mixture was transferred to vessel and the vessel was evacuated to a pressure of 0.01 mbar. The vessel was then heated to temperature of 155° C. and held at this temperature for 18 hours, the vessel was then cooled to room temperature and the resulting material was removed from the vessel. The resulting material takes the form of a sulfur-carbon composite and comprises particles of Maxsorb-III in which sulfur has been infiltrated and filled into the porous carbon host structure.

This sulfur/carbon composite material was then mixed with deionised water. The mixture was then wet milled using standard wet milling equipment to reduce the particle size. To the milled mixture a carbon black was added at 2 wt. % (based on the mass of solid components). The materials were then mixed to ensure a homogenous distribution of all components.

Separately, sodium carboxymethylcellulose was dissolved in deionised water to form a homogenous binder solution.

The two components were then combined and mixed until a homogenous mixture is formed with a binder content of 2 wt. % (based on wt. % of NaCMC, carbon black, sulfur and Maxsorb-III) to form an electrode slurry. The binder content of the electrode slurry is 2 wt. % (based on solids). The sulfur content of the electrode slurry mixture was 67 wt. % (based on solids).

The electrode slurry was then applied to an aluminium current collector and then dried, forming a cathode layer on the aluminium foil. The surface capacity of cathode layer was >4 mA h cm². The coated aluminium foil was then cut to form electrodes, which were further dried under reduced pressure prior to incorporation into electrochemical cells.

An electrolyte solution was formed via the dissolution of LiTFSI in dimethoxyethane (DME) to a molar concentration of 3.2 moles per litre of solution to form a liquid electrolyte.

Lithium foil was cut to form an electrode (referred to as an anode). A cell structure was formed via the placing of a separator membrane between an anode and a cathode as described above. Electrode tabs were connected to the anode and cathode individually. The cell structure is packaged within a housing made of laminate pouch material. An electrochemical cell was created when a liquid electrolyte was applied to the cell structure within the cell housing at a loading of <1.6 uL mA h⁻¹ of sulfur, enabling ion conduction between the anode and cathode. The electrochemical cell was sealed under reduced pressure. The cell was then connected to a MACCOR battery test system to characterise the electrochemical performance of the cell. The cell was initially discharged at a rate equivalent to C/10, assuming a theoretical capacity of sulfur to be 1672 mA h g⁻¹. During the initial discharge, an average voltage of 1.79 V was obtained, and a specific capacity of >1550 mA h g⁻¹. Based upon the mass of the electrochemical cell and the energy delivered by the cell during discharge a specific energy of >400 Wh kg⁻¹ was demonstrated.

### Example 2

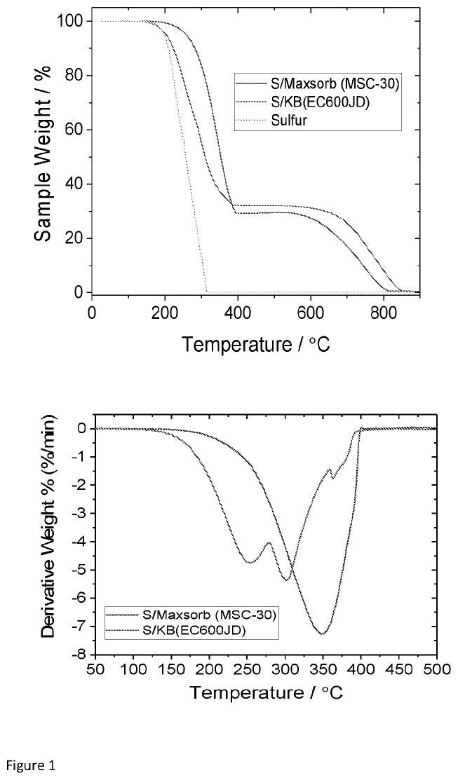

A carbon-sulfur composite was formed in accordance with Example 1. This carbon-sulfur composite comprised Maxsorb-III as the carbon host material and 70 wt % sulfur. A comparative carbon-sulfur composite was formed in which Maxsorb-III was substituted with Ketjen black. Ketjen black has a larger pore structure than Maxsorb-III, with an average pore diameter of approximately 6.7 nm (Ketjen black) compared to an average pore diameter of approximately 2.14 nm (Maxsorb-III). The average pore volume of Ketjen black is 2.1 cm³g⁻¹ and the average pore volume of Maxsorb-III is 1.79 cm³g⁻¹. It was found that the pore structure and pore volume of Maxsorb-III allows a high proportion of sulfur to have a strong interaction with the carbon host. This was demonstrated by means of thermogravimetric analysis. FIG. 1 shows the increase in temperature required to remove sulfur from the carbon-sulfur composite in which the carbon host is Maxsorb-III.

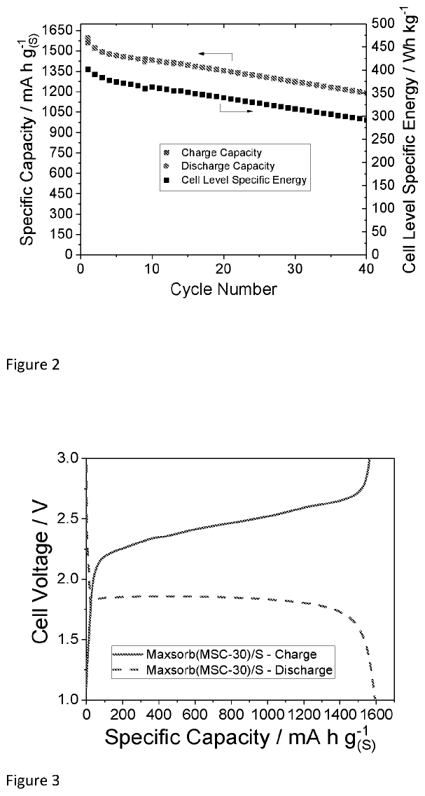

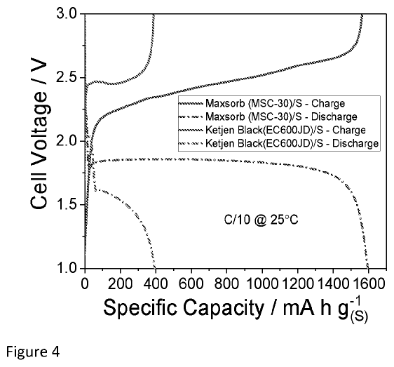

FIG. 2 shows cycle life and cell energy for the cell described in Example 1. FIG. 3 illustrates voltage profile for the first cycle of the electrochemical cell detailed in Example 1, with FIG. 4 providing a comparison of cell voltage and specific capacity of the exemplary cell (Example 1) and comparative cell (Example 2).

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-18. (canceled)

19. An electrochemical cell comprising:
an anode;
an electrolyte having a solubility for sulfur-containing species of less than 15 mM;
a cathode comprising greater than 65 wt. % sulfur, wherein the cathode comprises a carbon-sulfur composite material; and
wherein the composite material comprises greater than 65 weight % sulfur based on the total weight of the composite material; and wherein the carbon sulfur composite material is formed from an electroconductive carbon material having an average pore volume of 1.5-3 cm³ g⁻¹ and an average pore diameter of less than 3 nm.

20. The electrochemical cell of claim 19 wherein the electrolyte is selected from a liquid, polymer or gelled polymer electrolyte.

21. The electrochemical cell of claim 19 wherein the anode comprises an alkali metal or alkali metal alloy.

22. The electrochemical cell of claim 20 wherein the electrolyte comprises a solvent selected from at least one of linear ethers, diethyl ether (DEE),tetrahydrofuran (THF), Dimethoxyethane (DME), Dioxolane (DIOX), Diglyme, dimethyl carbonate (DMC), ethyl methyl carbonate (EMC), ethylene carbonate (EC), propylene carbonate (PC), methyl formate (MF), ethyl formate (EF), methyl propionate (MP), ethyl acetate (EA) and methyl butyrate (MB), methyl ethyl ketone, acetonitrile (ACN), propionitrile (PN), isobutyronitrile (iBN), Dimethylformamide (DMF), Dimethylacetamide (DMAc), N-Methyl-2-pyrrolidone (NMP), Tetramethylurea (TMU), Dimethyl sulfoxide (DMSO), Trimethyl phosphate, Triethyl phosphate, Hexamethylphosphoramide, toluene, benzene, heptane, xylene and dichloromethane; ionic liquids, halogenated ethers, gels and mixtures thereof; and at least one alkali metal salt.

23. The electrochemical cell of claim 22, wherein the alkali metal salt is selected from alkali metal salt is at least one lithium salt selected from lithium hexafluoroarsenate LiAsF6, lithium hexafluorophosphate LiPF6, lithium perchlorate LiCLO4, lithium sulfate Li2SO4, lithium nitrate LiNO3, lithium trifluoromethanesulfonate LiOTf, lithium bis(trifluoromethane) sulfonimide LiTFSI, lithium bis(fluorosufonyl)imide LiFSI, lithium bis(oxalate)borate LiBOB, lithium difluoro(oxalate)borate LiDFOB, lithium bis(pentafluoroethanesulfonyl)imide LiBETI, lithium 2-trifluoromethyl-4,5-dicyanoimidazole LiTDI and combinations thereof.

24. The electrochemical cell of claim 19 wherein the electroconductive carbon host material which forms the S/C composite material has an average pore volume of 1.5-2 cm³ g⁻¹ and an average pore diameter of 1 nm to 3 nm.

25. The electrochemical cell of claim 19, wherein at least 45% of the pores in the electroconductive carbon material have a diameter falling within the range of 1-3 nm.

26. The electrochemical cell of claim 19, wherein the cathode further comprises electronically conductive carbon additives such as carbon black and carbon nanotubes, and optionally further comprises a binder.

27. The electrochemical cell of claim 19, wherein the sulfur material comprises elemental sulfur; or an alkali metal sulfide, for example Li2S.

28. The electrochemical cell of claim 19, wherein the electrolyte has a density of less than 1.5 g cm³.

29. The electrochemical cell of claim 19, wherein the anode comprises at least one protection layer, wherein the protection layer is optionally selected from a metal and/or non-metal that alloys with an alkali metal, an ionically conducting layer having an electronic conductivity of less than 10⁻⁵ S cm⁻¹; or combinations thereof.

30. The electrochemical cell of claim 19, wherein the electrochemical cell is a lithium sulfur cell.

31. A cell assembly comprising at least one electrochemical cell in accordance with claim 19, and a means of applying pressure to the at least one electrochemical cell or cells.

32. A method for forming an electrochemical cell as claimed in claim 19, said method comprising:
a. providing a carbon host material having an average pore volume of 1.5-3 cm³ g⁻¹ and an average pore diameter of less than 3 nm;
b. introducing sulfur into the carbon host material to form a composite material;
c. depositing said composite material onto a current collector to form a cathode;
d. placing the cathode in contact with an electrolyte having a polysulfide solubility of less than 15 mM; and placing an anode in contact with the electrolyte.

33. The method as claimed in claim 32 wherein said composite material is dispersed in a solvent to form a slurry, and wherein the slurry is deposited onto the current collector.

34. The method as claimed in claim 32, further comprising the step of grinding or milling the carbon host material prior to introducing sulfur to the carbon host material; and, optionally, selecting carbon particles having a diameter of from 0.5 to 50 μm.

35. The method as claimed in claim 32, further comprising grinding or milling the composite material; and, optionally, selecting composite particles having a diameter of from 0.5 to 50 μm.

36. The method of claim 32, wherein the electrochemical cell is a lithium sulfur cell.
